(19) United States
(12) Patent Application Publication
(10) Pub. No.: US 2015/0095964 A1
(43) Pub. Date: Apr. 2, 2015

(54) BUMPER VIDEO CAROUSEL FOR DIGITAL VIDEO DELIVERY

(71) Applicant: OpenTV, Inc., San Francisco, CA (US)

(72) Inventor: John Michael Teixeira, Oakland, CA (US)

(73) Assignee: OPENTV, INC., San Francisco, CA (US)

(21) Appl. No.: 14/043,746

(22) Filed: Oct. 1, 2013

(51) Int. Cl. H04N 21/235; H04N 21/231

(52) U.S. Cl. CPC H04N 21/2353; H04N 21/23106
USPC 725/116

(57) ABSTRACT

When a use device makes a request to watch a live program that is yet to become available at a server for streaming to the user device, a secondary program may be provided to the user device. The secondary program may be made available as a carousel of short duration video segments that are looped for viewing at the user device. When the live program becomes available, the secondary program may be replaced with live program in a visually seamless manner.

### BACKGROUND

This document relates to delivery of digital video programs and, in one aspect, user experience during channel changes.

Digital video delivery systems offer improved video quality over conventional analog video delivery systems. In various digital video delivery systems, content streaming is used for transferring video content along with the associated audio from a source device to a user device such as a computer or mobile device. In streaming, content transfer is achieved by downloading content segments of a certain time duration. In some implementations, the source device, or content server, provides a descriptor file or an index file to the user device, for the user device to request specific segments of content for download to the user device.

### SUMMARY

In some disclosed embodiments, when a user device makes a request to watch a live program that is yet to become available at a server for streaming to the user device, a secondary program is provided to the user device. In some disclosed embodiments, the secondary program is made available as a carousel of short duration video segments that are looped for viewing at the user device. In some disclosed devices, a user device is controlled to send requests for additional video content after a fixed time period. When the live program becomes available, the secondary program is replaced with live program in a visually seamless manner.

In one exemplary aspect, a method of streaming requested content to a user device is disclosed. The method includes transmitting, from a server device, program information indicating that a primary multimedia program is available for viewing, prior to the primary multimedia program being ready for streaming at the server device, receiving a first request for the primary multimedia program prior to the primary multimedia program being ready for streaming, transmitting, in response to the request, a first media descriptor for one or more segments of a secondary multimedia program, receiving a second request for content based on the media information for the one or more segments of the secondary multimedia program, determining, after receiving the second request, whether the primary multimedia program is ready for streaming, providing, when the primary multimedia program is ready for streaming, a second media descriptor for the primary multimedia program, and providing, when the primary multimedia program is not ready for streaming, a third media descriptor for the secondary multimedia program.

In another aspect, an apparatus for providing a requested multimedia program to a user is disclosed. The apparatus includes a guide module that provides program guide information indicating availability of multimedia programs at the apparatus, a receiver module that receives a multimedia program request, an availability determination module that checks whether segments for the requested multimedia program are available in a storage controlled by the apparatus and a bumper video module that, when the availability determination module determines that segments for requested multimedia program are not available, provides a second multimedia data and causes a user device to repeatedly request additional segments such that when segments for requested multimedia program become available, the bumper video module causes a transmission module to transmit the segments of the requested multimedia program.

In yet another embodiment, a computer program product having a computer-readable program medium with code stored thereupon is disclosed. The code, when executed, causing a processor to implement a method of providing a live program for viewing. The method includes receiving a request for a live program prior to availability of the live program for streaming, making available segments of a secondary program while preparing the live program for streaming, making available a segment of the secondary program wherein the segment of secondary program is made available after receiving a corresponding content request, noting an availability time at which the live program becomes available for streaming and streaming, the live program in response to a next content request receiver after the availability time.

These, and other, aspects are described below in the drawings, the description and the claims.

### BRIEF DESCRIPTION OF THE DRAWINGS

FIG. 1 depicts high level architecture of an example communication network.

FIG. 2 depicts an example sequence of content requests and corresponding media descriptor files.

FIG. 3 illustrates an example carousel of index files.

FIG. 4 is a flowchart of an example method of providing live program to a user device.

FIG. 5 is a flowchart of an example method for providing live program to a user device.

FIG. 6 is a block diagram example of an apparatus for providing live program to a user device.

FIG. 7 is a flowchart of an example method for providing live program to a user device.

Like reference symbols in the various drawings indicate like elements.

### DETAILED DESCRIPTION

Commonly practiced streaming techniques such as buffering of a certain number of content segments may cause long delays in “channel changes”, i.e., a time difference between when a user requests a different program to the time the requested program appears on the user's display, that may be unacceptable to certain users. Often, multimedia programs of interest to viewers are live. For example, live programming may be a breaking news story, or a sports event or an audio or video program being broadcast over a communication network while the event is taking place in real world. A user device (e.g., a set-top box, a computer, a smartphone, a tablet, etc.) may make the user aware of the availability of live programming through a program guide or other audio/visual cues such as pop-up windows of or scrolling text on the display (e.g., emergency alerts). However, when the user selects to view the live program, at that instant, that live program may not be available, or ready for streaming, at the source of the program.

Several well-known industry techniques such as the hypertext transfer protocol (HTTP) live streaming protocol (HLS) from Apple or similar streaming techniques from Microsoft, Google, Adobe, etc. provide for techniques for transmission of content (sometimes called streaming) from a server device to a receiving device (user device). Using these techniques, the server device makes content available in segments of video (e.g., 2 second or 10 second segments) for user devices to fetch these segments by sending requests to the server device. In some embodiments, the availability of these segments is conveyed to the user devices in the form of a media descriptor file that lists details such as universal resource locator (URL) for each segment and the time period for which the segment corresponds to.

Some video streaming protocols, such as Apple's HTTP Live Streaming (HLS,) are primarily designed for use with static media files. When a client (a user device) requests an index file describing the available media streams, that client may expect media to already exist and be immediately available for consumption. If the returned index file is empty (e.g., because the content is not available at the server) the client may discontinue further requests. The above-described scenario of live content creates a situation where a client could request programs that are not currently ready but will be available after some time-consuming preparations. Various existing streaming technologies do not offer solutions for a server device to indicate to the client that it should wait for an amount of time before which the requested content will be available. Even if existing interoperability specifications such as Apple's HLS were modified to add such a “wait” message, legacy clients may not be able to understand this new message. Therefore any unavoidable delay in initializing a live stream (e.g. tuning a channel, adjusting the transcoder, etc. . . . ) or temporary loss of media content could result in a communication breakdown between the server and a user device that may be an unwanted experience for a user.

When a user tunes to a new program, either by up/down channel change or by direct selection, the user typically has an expectation to see a corresponding change in pictures displayed to him within a reasonable channel change time. A channel change time between 0.4 seconds to 2 seconds is often considered to be reasonable for user experience. However, when content is live, or when content is stored in a far storage that is not available to the server to meet the acceptable channel change time period, the following user scenario might happen:

Step 1: User tunes to a new channel

Step 2: User sees no program change on his display (previous channel being shown) or display goes to a static screen (e.g., black screen) for duration of time. During this time, the server may be receiving content from far storage or may be buffering a sufficient amount of live content for segment-based transmission to the user.

Step 3: User either patiently waits for the new cannel to appear on his display, or the user becomes impatient and navigates to another channel.

In other scenarios, the player and/or client that is playing the media may itself have timeouts which may be shorter than the tune time. Typically, in such scenarios, the server has no control over the timeout of the player/client, or the client retries. In such scenarios, it may be desired to keep the application that is playing the media engaged.

The techniques disclosed in the present document, in one aspect, can be used to implement a more desirable scenario from a user experience perspective. For example, a channel change to a live program or a program stored in a far storage:

Step 1: User tunes to a new channel

Step 2: A secondary program is presented to the user within the acceptable channel change time (e.g., an advertisement or some other interesting information such as current weather or previews) for a duration of time. During this time, the server may be fetching the content from far storage or may be buffering a sufficient amount of live content for subsequent segment-based transmission to the user.

Step 3: While the user is watching the secondary video program, new program begins to play out on the display in a visually seamless manner.

In some embodiments disclosed in this document, a carouseling mechanism may be used. In this mechanism, a server device may receive a request for a program, control delivery of a secondary program instead of the requested program such that short duration segments of the second program (e.g., 1 to 3 second segments) are carouseled to the user device and replace the secondary program with the requested program after the requested program becomes available to the server device. In some embodiments, the carouseling of secondary program may be achieved by rotating a certain number of descriptor files such that the user device loops on the secondary program (“bumper video”) under the control by the server device. These, and other embodiments, are described in the present document.

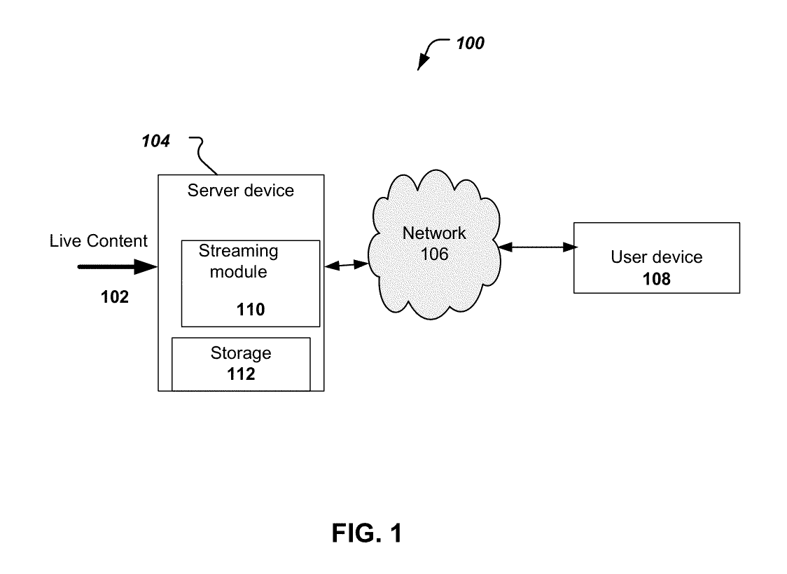

FIG. 1 shows an example of a system 100 having a server device 104 that includes a streaming server module 110 and a content storage 112 that receives live content 102. In various embodiments, the server device 102 can be implemented by a digital or analog cable set-top box, a satellite receiver, a home gateway device, an over-the-top box, a computer, a smartphone, etc. Correspondingly, the live content 102 may be received over a digital cable interface, an analog cable interface, a satellite signal, a broadband internet connection, a wireless local area network (e.g., Wi-Fi), a wide area cellular connection (e.g., 3G or 4G long term evolution or LTE, WiMax, etc.) and so on. The server device 104 may be communicatively coupled with a user device 108 over a communication network, e.g., an in-home network 106. The term “in-home” is used for simplicity and the network 106 may be wired or wireless and be deployed in a user residence or a commercial or a public place (e.g., airport, restaurant) and may be indoor or outdoor. Some examples of the in-home network 106 include 802.11x (Wi-Fi), Bluetooth, Wireless Universal Serial Bus (USB), and so on.

One way to ensure a user's continued attention is to always have media available for the user to consume. In some embodiments disclosed in this document, a bumper video with content suitable for playback in an infinite loop is provided for user consumption. This video can be pre-processed into segments as small as the server in capable of supporting. Multiple small segments can be advantageous, in one aspect, because smaller segment sizes can shorten the user's transition from the bumper video to the requested video content. Also, some protocols, e.g., HLS, have minimum segment requirements for listing in index files. The content of the secondary video can be anything—an advertisement, a news item, a static screen (e.g., a “please standby” message), etc.

With the bumper video segments stored in storage 112, the server device 104 can rotate the segments advertised in the index file sent to the user device. The index file (e.g., M3U8 format for HLS) is a play-list informing the client of the URIs of video segments and the order in which those sequences should be played. Constantly expanding play-lists are allowed for by the protocols. These playlists indicate to a user device availability of additional content after the user device reaches the end of the current index file. Alternatively, this may be accomplished by providing an explicit indication of a time period over which the currently send index file is active or valid.

For example, the HLS protocol allows for the absence of the “#EXT-ENDLIST” tag. If an M3U8 file does not include this tag then the client is to assume more segments will be advertised in subsequent M3U8 files. Therefore, the client knows to keep requesting these index files until the end-of-stream message is finally present within a returned index file.

When an index file is requested prior to the actual content being available, an intermediate index file can be created by the server (or be selected from a pre-stored intermediate index file) which would references the segments of the bumper video. The segments listed in this intermediate index file will increment in a cyclical rotation.

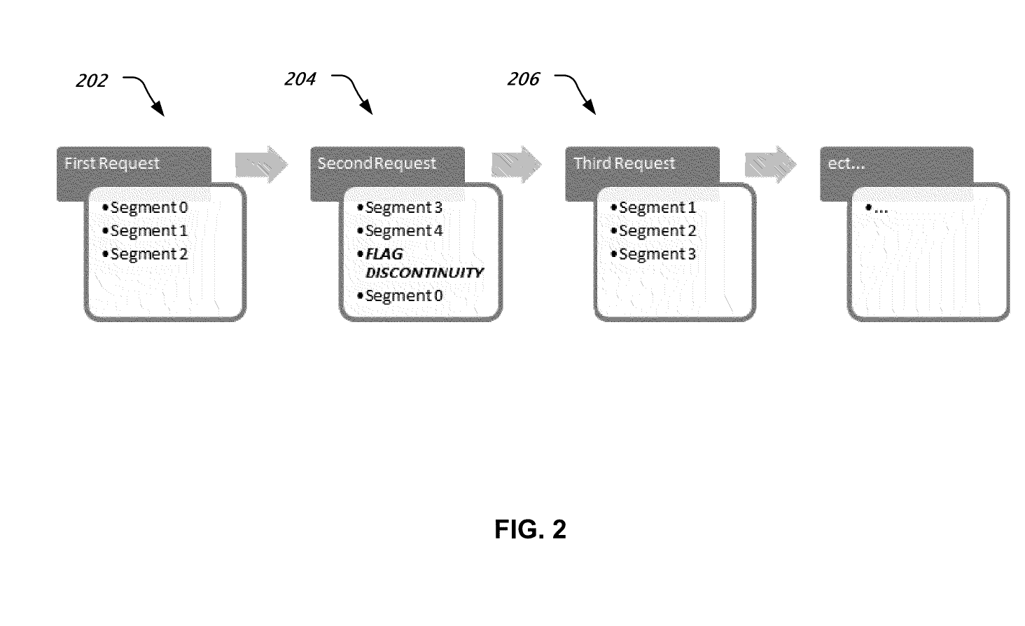

FIG. 2 depicts an example of how a server can control carouseling or cyclic rotation of the second video program transmitted to a user device. For example, the initial request 202 to a system with a 5-segment bumper video may return a playlist consisting of entries for Segment 0, Segment 1, and Segment 2. The second request 204 (assuming the actual requested content is still unavailable) may return Segment 3, Segment 4, and Segment 0 listed again at the end of the list. Similarly, a third request 206 may list segment 1, segment 2 and segment 3. The overall count of served segments is specified by some protocols to differentiate the listed segments of multiple index files. (This total count is called a “sequence” number by the HLS protocol.) This sequence number could be maintained for each client authorized to receive index files. Alternatively, a global sequence number could be maintained for systems allowing anonymous access.

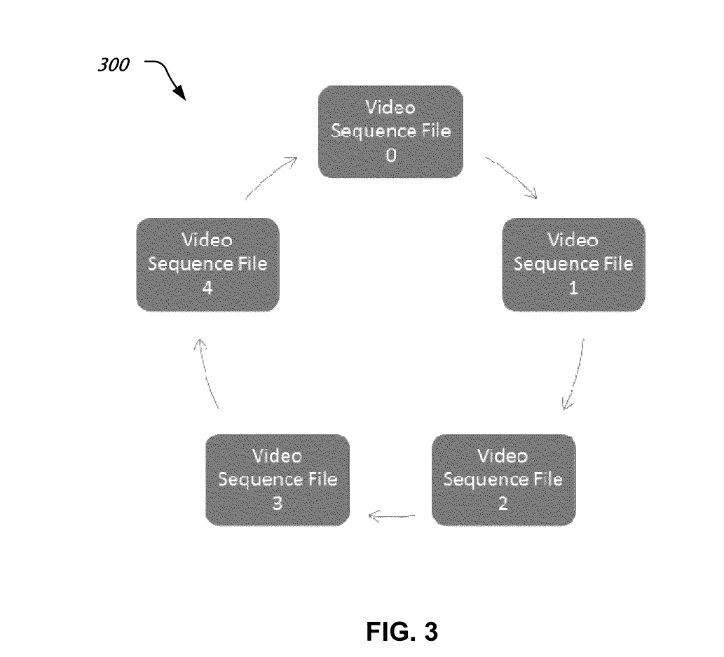

FIG. 3 is an example of a block diagram representation of carouseling of index files (which in turn leads to carouseling of video segments). For a finite number of video segments, there may be a finite number of video sequences possible. For example for a 5-segment secondary program, five possible index files may be possible, each starting with one of the five segments. As depicted in FIG. 3, these index files may be carouseled to the user device, thereby controlling the user device to loop on the secondary video segments.

Many video streaming formats for index files allow for a “discontinuity” flag to be included anytime there is break in the continuity of the video packets, for example, a time code that seems to skip backwards. Such a flag should be employed when the system loops back to the beginning and this flag should be placed between segment-n and segment-0 in the index file's playlist. A user device may use the discontinuity indication to reinitialize its codec in preparation of the discrepancies caused by the loop-back.

Some streaming media user devices are designed to pre-fetch and buffer as much data as possible, e.g., to make sure that a large amount of program is locally cached so that any network glitches can be smoothened out. This pre-fetching and buffering may have a detrimental impact on channel change transition time to live program because the user device may not begin displaying live programming as soon as it is sent to the user device due to the pre-fetched and buffered secondary program data ahead of it in the display queue. Using an existing protocol such as the HLS protocol, the play-list (index file) is an opaque stream for data fetching and playback, providing no opportunity to a server to indicate to the user device to discard already-cached secondary video content and begin playing live content. Allowing the client to cache large amounts of the bumper video could thus delay the transition between the cached bumper video and the requested content as the player plays though all its cached data. In some embodiment the server may uniquely identify the user device being served (e.g., based on a digital certificate or a media access control MAC address) such that the server disables dispatch of additional media descriptor files to the identified user device, thereby taking away the user device's ability to run too far ahead. In some embodiments, when new index files are generated on-the-fly, the generation of new index files may be controlled by current time, e.g., no index file may be generated which lists a video segment that can be played out beyond 2 or 4 seconds of the current time.

Some server embodiments may allow anonymous access by multiple user devices. In such cases, the user devices can be kept in synchronization by allowing a mathematical calculation to dictate what segments are advertised in a new index file. One possible governing function f(t)=┌t/d┐ mod n will return the index number of the first segment to be advertised where t is the time at which the index file was requested, d is the duration of the video segments, and n is the number of segments that make up the complete bumper video.

In server embodiments where a greater control and individual tracking can be implemented, the server can store a sequence number for each user device being served and monitor when the last index file request was received. Since the sequences are tied to a single client the sequence number can simply be incremented through cyclical index values. However, if the next request comes in faster than the client could have played through an acceptable portion of the previously advertised segments, then the same index file (i.e. same sequence number and URIs) is returned to the client.

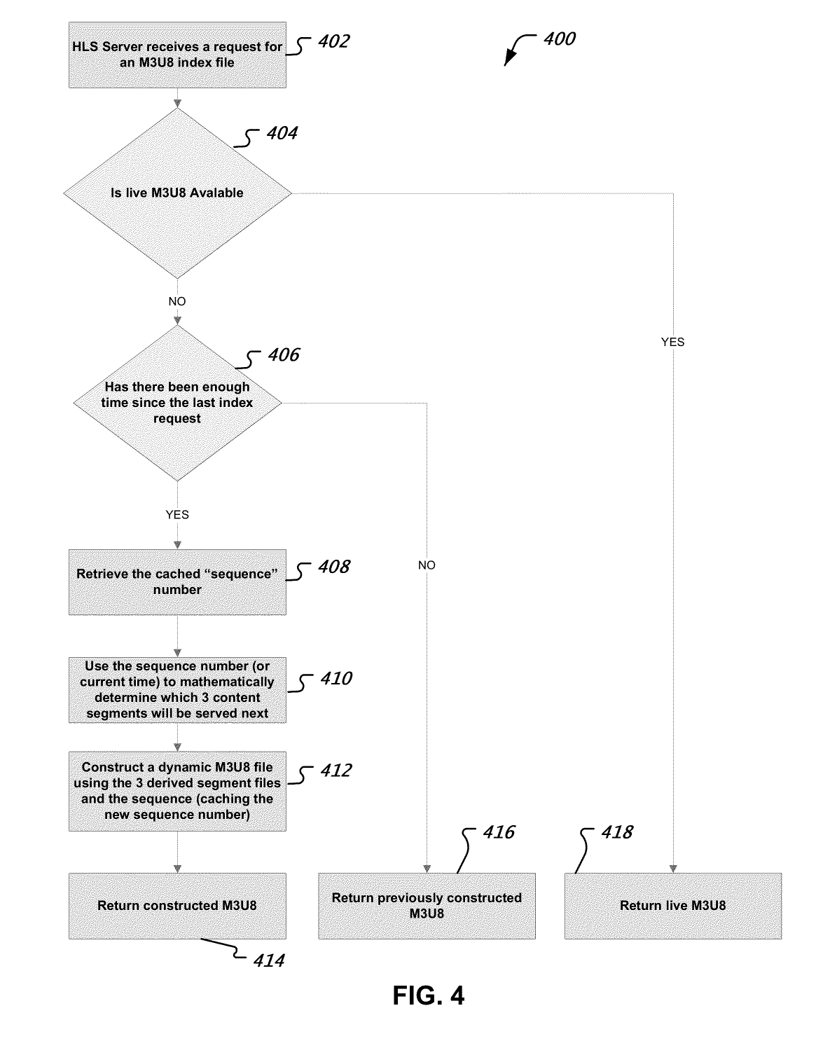

FIG. 4 is a flowchart description of an example embodiment of a process 400 when HLS protocol is used for interactions between a server and a user device.

At 402, an HLS server receives a request for an M3U8 file. At 404, the HLS server checks whether the requested file is a live file that is available at the HLS server. If the file is available, the HLS server returns the requested file to the requester user device. The user device may then start downloading the content listed in the index file.

If, at 404, the HLS server determines that the requested file is not available, the HLS server may check, at 406, whether sufficient time has elapsed since the last time an index file request was received from the requesting user device. This time may be a function of a target channel change time. If sufficient time has not elapsed, then, at 416, the HLS server may return a previously constructed M3U8 file. Otherwise, at 408, the HLS server may retrieve a cached identifier, or a sequence number, for the index file to serve. At 410, based on the sequence number, or a current time, the server may determine which N number of segments (N an integer, e.g., 3) should be served out next. At 412, based on the determination, the server may dynamically construct (or alternatively, retrieve from a number of pre-constructed files) an M3U8 file that lists the 3 derived segments files and the sequence. At 414, the server may return the dynamically constructed (or retrieved) M3U8 file to the requesting user device.

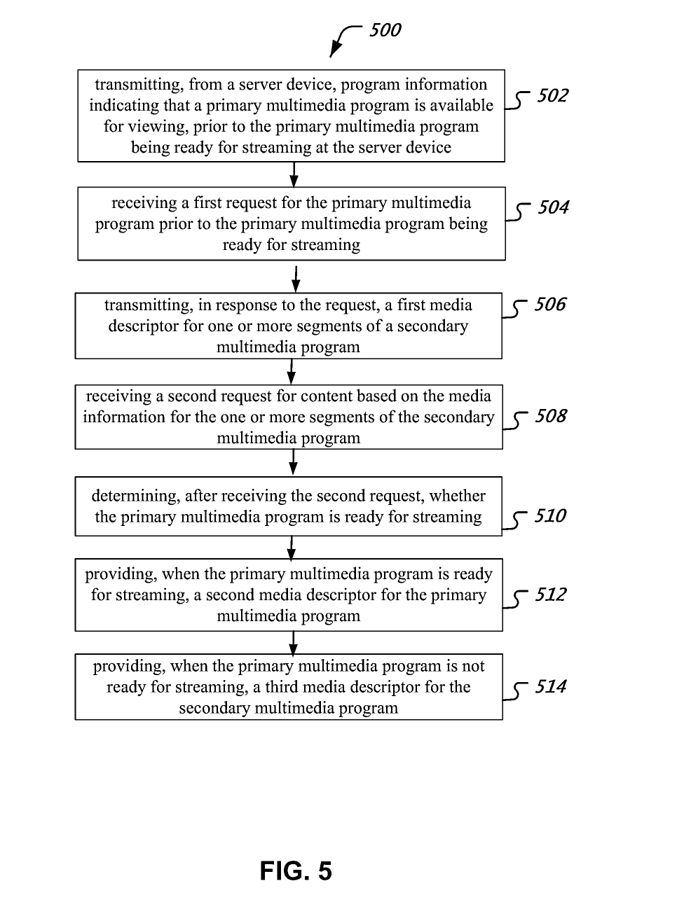

FIG. 5 is a flowchart representation of an example method 500 of streaming requested content to a user device. The method 500 may be implemented, e.g., at the server device 104.

At 502, the method 500 transmits program information indicating that a primary multimedia program is available for viewing, prior to the primary multimedia program being ready for streaming at the server device. In some embodiments, the method 500 provides program guide data to the user device. The program guide data may include live program listing even before content for the live program is available at the server.

At 504, the method 500 receives a first request for the primary multimedia program prior to the primary multimedia program being ready for streaming.

At 506, the method 500 transmits, in response to the request, a first media descriptor for one or more segments of a secondary multimedia program.

At 508, the method 500 receives a second request for content based on the media information for the one or more segments of the secondary multimedia program.

At 510, the method 500 determines, after receiving the second request, whether the primary multimedia program is ready for streaming. The determination may include checking whether a pre-defined number of segments (e.g., two to five) of the primary multimedia segments are available for downloading by a user device.

At 512, the method 500 provides, when the primary multimedia program is ready for streaming, a second media descriptor for the primary multimedia program. The second media descriptor may include, e.g., entries corresponding to each of the pre-defined number of segments, wherein the entries provide a universal resource indicator at which the corresponding segment is available on the server device.

At 514, the method 500 provides, when the primary multimedia program is not ready for streaming, a third media descriptor for the secondary multimedia program.

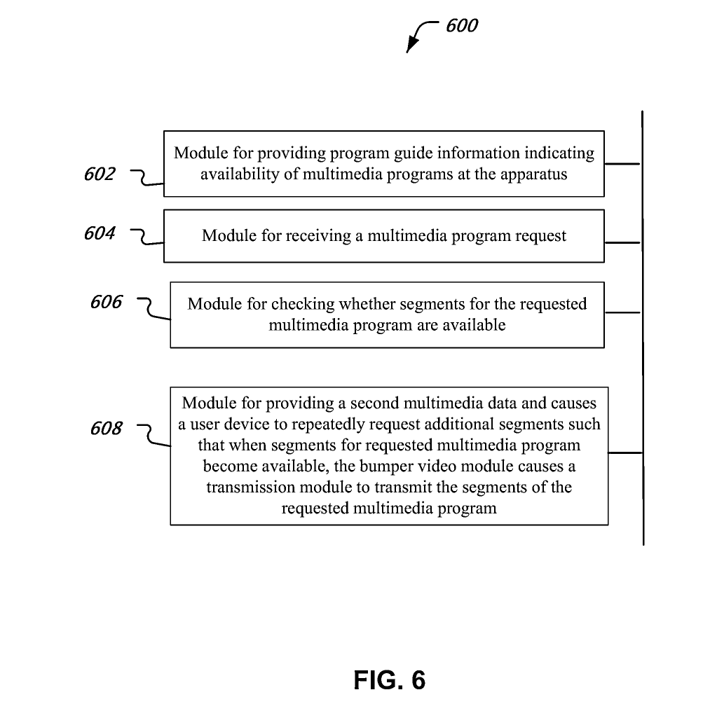

FIG. 6 is a block diagram depiction of an example apparatus 600 for providing a requested multimedia program to a user. The module 602 (e.g., a guide module) provides program guide information indicating availability of multimedia programs at the apparatus. The module 604 (e.g., a receiver module) receives a multimedia program request. The module 606 (e.g., an availability determination module) checks whether segments for the requested multimedia program are available in a storage controlled by the apparatus. The module 608 (e.g., a bumper video module) when the availability determination module determines that segments for requested multimedia program are not available, provides a second multimedia data and causes a user device to repeatedly request additional segments such that when segments for requested multimedia program become available, the bumper video module causes a transmission module to transmit the segments of the requested multimedia program.

In some embodiments, the bumper video module causes the user device to repeatedly request additional segments by sending a media descriptor file that omits an end-of-file entry.

In some embodiments, the apparatus 600 further includes a streaming data preparation module that, during a time when the second multimedia data is provided to the user device, prepares data corresponding to the requested multimedia program for streaming. In some embodiments, the streaming data preparation module includes a data source module that receives the requested multimedia program, a segmenter module that segments the received requested multimedia program into a plurality of segments and a segment storage module that stores the plurality of segments in the storage. In some embodiments, the second multimedia data comprises one or more advertisements. In some embodiments, segments of the second multimedia data are designed to provide a visually seamless experience when played back in a loop. In some embodiments, the module 608 further controls a number of additional segments transmitted to the user device to be less than a pre-determined number.

In some implementations, the method 500 controls the first media descriptor to be operative over a first time period. For example, as previously disclosed, the time period may be designed to minimize the amount of wait time for a user before which live programming is viewed. The first time period may, e.g., be controlled by indicating in the first media descriptor availability of additional media descriptors corresponding to the time beyond the first time period. For example, this indication may be done in M3U8 files by leaving M3U8 files “open” by excluding end of file indication. Alternatively, an explicit message may be sent in the descriptor file indicating availability of additional content.

In some implementations, the method 500 processes, between a first time at which program information indicating that the primary multimedia program is available for viewing and a second time at which the primary multimedia program is ready for streaming, data packets for the primary multimedia program, wherein the processing includes receiving the data packets via a first network interface, and dividing the data packets into media segments that are downloadable over a second network interface. In some embodiments, the processing comprises changing a quality level (e.g., a bitrate) of the data packets received over the live content interface 102.

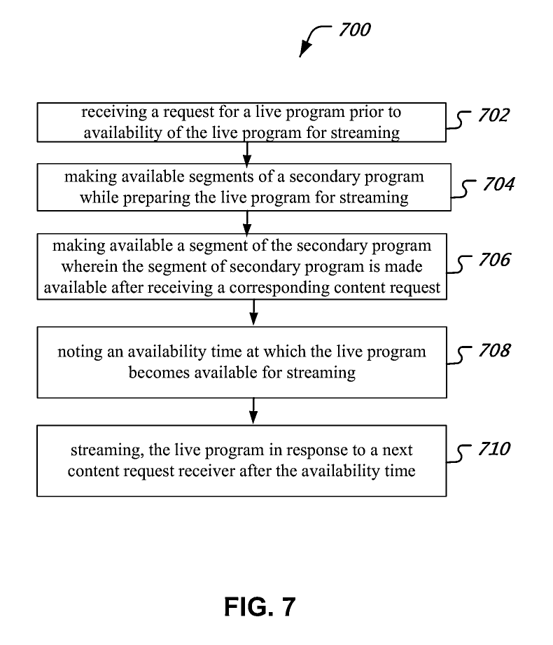

FIG. 7 is a flowchart representation of an example of a process 700 for providing a live program for viewing.

At 702, the process 700 receives a request for a live program prior to availability of the live program for streaming.

At 704, the process 700 makes available segments of a secondary program while preparing the live program for streaming.

At 706, the process 700 makes available a segment of the secondary program wherein the segment of secondary program is made available after receiving a corresponding content request. In some embodiments, the process 700 makes available the segment by transmitting the segment of the secondary program over a communication network.

At 708, the process 700 notes an availability time at which the live program becomes available for streaming.

At 710, the process 700 streams, the live program in response to a next content request receiver after the availability time.

In some embodiments, the secondary program is sent to a user device prior to receiving the request for the live program and wherein the making available operation 706 comprises instructing the user device to retrieve the segment of the secondary program from a local memory of the user device.

In some embodiments, a digital video communication network includes a content server coupled to the communication network and a user device coupled to the communication network. The content server us configured to advertise, prior to availability of a live program in a storage of the content server, the live program to the user device, make available a segment of a secondary program, when the user device requests the live program prior to availability of the live program in the storage of the content server, and make available the live program to the user device, when the user device requests the live program after availability of the live program in the storage of the content server. The user device is configured to repeatedly request additional content from the content server and display received content on a display associated with the user device.

It will be appreciated that techniques are disclosed to allow channel changes to live programming by providing viewable secondary content to a user. In one helpful aspect, the viewable secondary content improves user experience during channel changes. In another advantageous aspect, the secondary content may retain the user's attention to the requested program. It will further be appreciated that the secondary content may be provided as a rotating carousel of short video segments such that the secondary content can be replaced with live content when live content becomes available.

It will further be appreciated that, some disclosed embodiments can be implemented in a communication network that uses an industry-standard streaming protocol such as the HLS protocol.

The disclosed and other embodiments, the functional operations and modules described in this document (e.g., a content receiver module, a storage module, a bitstream analysis module, a credit determination module, a playback control module, a credit exchange module, etc.) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

As a specific example, an example processing code is included below to illustrate one implementation of the above disclosed processing.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of streaming requested content to a user device, comprising:
transmitting, from a server device, program information indicating that a primary multimedia program is available for viewing, prior to the primary multimedia program being ready for streaming at the server device;
receiving a first request for the primary multimedia program prior to the primary multimedia program being ready for streaming;
transmitting, in response to the request, a first media descriptor for one or more segments of a secondary multimedia program;
receiving a second request for content based on the media information for the one or more segments of the secondary multimedia program;
determining, after receiving the second request, whether the primary multimedia program is ready for streaming;
providing, when the primary multimedia program is ready for streaming, a second media descriptor for the primary multimedia program; and
providing, when the primary multimedia program is not ready for streaming, a third media descriptor for the secondary multimedia program.

2. The method of claim 1, further comprising:
controlling the first media descriptor to be operative over a first time period.

3. The method of claim 2, further comprising:
indicating in the first media descriptor availability of additional media descriptors corresponding to time beyond the first time period.

4. The method of claim 1, wherein the transmitting the program information indicating that the primary multimedia program is available for viewing includes providing electronic program guide data.

5. The method of claim 1, further comprising:
processing, between a first time at which program information indicating that the primary multimedia program is available for viewing and a second time at which the primary multimedia program is ready for streaming, data packets for the primary multimedia program, wherein the processing includes receiving the data packets via a first network interface, and dividing the data packets into media segments that are downloadable over a second network interface.

6. The method of claim 5, wherein the processing further comprises changing a quality level of the received data packets.

7. The method of claim 1, wherein the operation of determining whether the primary multimedia program is ready for streaming includes:
checking whether a pre-defined number of segments of the primary multimedia segments are available for downloading by a user device.

8. The method of claim 7, wherein the second media descriptor includes entries corresponding to each of the pre-defined number of segments, wherein the entries provide a universal resource indicator at which the corresponding segment is available on the server device.

9. An apparatus for providing a requested multimedia program to a user, comprising:
a guide module that provides program guide information indicating availability of multimedia programs at the apparatus;
a receiver module that receives a multimedia program request;
an availability determination module that checks whether segments for the requested multimedia program are available in a storage controlled by the apparatus; and
a bumper video module that, when the availability determination module determines that segments for requested multimedia program are not available, provides a second multimedia data and causes a user device to repeatedly request additional segments such that when segments for requested multimedia program become available, the bumper video module causes a transmission module to transmit the segments of the requested multimedia program.

10. The apparatus of claim 9, wherein the bumper video module causes the user device to repeatedly request additional segments by sending a media descriptor file that omits a an end-of-file entry.

11. The apparatus of claim 9, further including:
a streaming data preparation module that, during a time when the second multimedia data is provided to the user device, prepares data corresponding to the requested multimedia program for streaming.

12. The apparatus of claim 11, wherein the streaming data preparation module includes a data source module that receives the requested multimedia program, a segmenter module that segments the received requested multimedia program into a plurality of segments and a segment storage module that stores the plurality of segments in the storage.

13. The apparatus of claim 9, wherein the second multimedia data comprises one or more advertisements.

14. The apparatus of claim 9, wherein segments of the second multimedia data are designed to provide a visually seamless experience when played back in a loop.

15. The apparatus of claim 9, wherein the bumper video module further controls a number of additional segments transmitted to the user device to be less than a pre-determined number.

16. A computer program product having a computer-readable program medium with code stored thereupon, the code, when executed, causing a processor to implement a method of providing a live program for viewing, comprising:
receiving a request for a live program prior to availability of the live program for streaming;
making available segments of a secondary program while preparing the live program for streaming;
making available a segment of the secondary program wherein the segment of secondary program is made available after receiving a corresponding content request;
noting an availability time at which the live program becomes available for streaming; and
streaming, the live program in response to a next content request receiver after the availability time.

17. The computer program product of claim 16, wherein the making available operation comprises:
transmitting the segment of the secondary program over a communication network.

18. The computer program product of claim 16, wherein the secondary program is sent to a user device prior to receiving the request for the live program and wherein the making available operation comprises:
instructing the user device to retrieve the segment of the secondary program from a local memory of the user device.

19. A digital video communication network, comprising:
a content server coupled to the communication network and a user device coupled to the communication network, wherein:
the content server is configured to
advertise, prior to availability of a live program in a storage of the content server, the live program to the user device;
make available a segment of a secondary program, when the user device requests the live program prior to availability of the live program in the storage of the content server;
make available the live program to the user device, when the user device requests the live program after availability of the live program in the storage of the content server; and
wherein the user device is configured to:
repeatedly request additional content from the content server; and
display received content on a display associated with the user device.

20. The communication network of claim 19, wherein the user device further comprises a local storage in which the secondary program can be cached for future use.
